(19) United States
(12) Patent Application Publication
(10) Pub. No.: US 2007/0269143 A1
(43) Pub. Date: Nov. 22, 2007

(54) Bag Resealing System

(76) Inventor: Charles P. Hickey, Cheyenne, WY (US)

Correspondence Address: BOYLE FREDRICKSON S.C., 840 North Plankinton Avenue, MILWAUKEE, WI, 53203, US

(21) Appl. No.: 11/736,921

(22) Filed: Apr. 18, 2007

Related U.S. Application Data
(60) Provisional application No. 60/801,214, filed on May 17, 2006.

(51) Int. Cl. B65D 33/16; B31B 1/00

(52) U.S. Cl. 383/64; 493/267

(57) ABSTRACT

The present invention is a bag resealing system capable of being applied to an existing bag structure in order to form a releasable closure thereon. The system includes a support strip of suitable material having an adhesive disposed on one side thereof in order to attach the system to the exterior of a bag and an aperture formed in the support strip. The system also includes a closure mechanism disposed on the support strip opposite the adhesive in an airtight manner completely around the aperture and including a pair of releasably engageable members disposed opposite the adhesive. The attachment of the closure mechanism on the support strip provides clearance between the mechanism and the support strip to enable the mechanism to open and define an opening therein in alignment with the aperture, which enables the mechanism to be selectively opened and closed to expose the aperture in the support strip.

### CROSS-REFERENCE TO RELATED APPLICATIONS

This application claims priority under 35 U.S.C. §119(e) from U.S. Provisional Patent Application Ser. No. 60/801,214, filed on May 17, 2006, the entirety of which is herein incorporated by reference.

### FIELD OF THE INVENTION

The present invention relates to bags and, more specifically, to a closure adapted to be positioned on existing plastic or foil bags to allow the bags to be opened and resealed as necessary.

### BACKGROUND OF THE INVENTION

Plastic and foil bags have long been utilized to hold a variety of items, including food products, therein for transportation and resale. A large number of bags of this type include mechanisms disposed thereon which enable the bag to be opened and resealed in a manner that prevents spoilage or spillage of the contents of the bag. The majority of these closure devices include a pair of opposed engageable sections that can be selectively disengaged from one another to provide access to the contents within the interior of the bag, and then re-engaged with one another to close the bag.

An improvement to closure devices of this type has been the inclusion of a sliding opener or zipper that is operable to mechanically engage and disengage the opposed portions of the closure device without the need for manually separating the opposed portions. The zipper device allows an individual to more easily open and close a bag as desired, while also providing a more reliable mechanism to securely engage the opposed sections of the closure device with one another to close the bag.

However, in order to utilize any of these closure mechanisms with a plastic bag or other similar type of bag, it has heretofore been necessary to include the closure mechanism within the original construction of the plastic bag.

One device in particular that has been developed for use with existing bags is disclosed in Ausnit U.S. Pat. No. 4,691,373. In this reference, a zipper closure is disclosed that is formed of a zipper strip including a pair of opposed strip members having interlocking attachment surfaces thereon. These attachment surfaces are each connected to an attachment flange that have an adhesive applied to one side, and that define an opening therebetween that can be selectively accessed by disengaging the attachment surfaces. The adhesive allows the attachment flanges, and consequently the zipper strip, to be secured to the exterior of a bag around an opening that has already been formed within the bag. The attachment flanges are secured on opposite sides of the opening, with the opening defined between the attachment flanges disposed in alignment with the preformed opening in the bag, such that the attachment surfaces can be utilized to selectively expose and cover the opening formed in the bag. The zipper strips are joined to one another lengthwise solely by the attachment surfaces on each strip member, and in some embodiments partially along their width by a seal formed directly across the zipper strip that fuses the strip members and the attachment surfaces at each side of the zipper strip.

However, the zipper strip of the '373 patent is disclosed solely for the attachment of the zipper strip over a preformed opening in the bag, such that the separate attachment flanges must be properly aligned with each side of the opening in the bag for the zipper strip to function correctly. This is often difficult to accomplish, because the material forming the bag is flexible and the opposed sides of the opening are hard to align with one another for the correct placement of the attachment flanges of the zipper strip along each side of the opening.

In addition, the zipper strip disclosed in the '373 patent cannot be positioned on bags prior to forming an opening in the bag. This is because the opposed attachment surfaces on the strip members are initially connected to one another when the zipper strip is secured to the bag. The abutting configuration of the attachment flanges when secured on the bag as a result of the engagement of the attachment surfaces with one another prevents the attachment surfaces from being separated to provide sufficient clearance to access the bag between the attachment surfaces and form an opening in the bag between the attachment surfaces. Further, if the attachment surfaces are forced apart to provide sufficient clearance to form an opening, the engagement of the attachment flanges with immediately adjacent sections of the bag will result in tearing of the bag along lines not in alignment with the zipper strip, such that the zipper strip is no longer capable of providing a reclosable opening on the bag.

Therefore, it is desirable to develop a bag resealing system which can be utilized with existing bags to allow the bags to be opened and closed utilizing a resealable closure device. Further, the system should include a device that is positionable on an unopened bag and that enables an opening to be easily formed in the bag in alignment with an aperture defined by the device.

### SUMMARY OF THE INVENTION

According to a first aspect of the present invention, a bag resealing system is provided that includes a resealable closure device. The resealable closure device is formed from a number of sections of a suitable and, preferably, a thermoplastic material that include a resealing mechanism with disengageable members on the opposed sections that operate to secure the sections to one another and selectively form an opening therebetween. The mechanism is also attached to a separate bottom or lower support strip that supports the resealing mechanism and includes an amount of an adhesive applied to the support strip opposite the disengagable members, which allows the closure device formed of the mechanism and the support strip to be adhered to the exterior of a bag, such as a plastic bag. The adhesive is covered by a release liner to avoid the inadvertent attachment of the adhesive to a substrate, such as a bag, until such time as it is desired to adhere the device to a bag. Once the resealable closure device is adhered to the bag using the adhesive on the support strip, due to the clearance provided between the bag and the mechanism by the inclusion of the support strip, the disengagable members of the mechanism can be separated without damaging the bag to expose an elongate guide opening formed in the support strip in alignment with the aperture defined between the disengageable members. After the mechanism has been opened, the bag is punctured along a line or at a location in alignment with the guide opening in the support strip, such that the aperture defined by the resealing mechanism is positioned directly over the opening formed in the bag along the guide opening in the support strip. This opening can be formed by an attachment to a shuttle or slider disposed on the resealable closure device that operates to simultaneously puncture and form a slit in the bag along the guide opening in alignment with the closure device, or can be formed using a cutting device completely separate from the resealable closure device. In this manner, the resealable closure device including the resealing mechanism and the support strip secured to the mechanism and including the guide opening can be utilized to form resealable closures on bags that are not manufactured with releasable closures in their original construction. Thus, the resealing system can be easily manufactured and utilized to retrofit a number of different unopened bag structures with a resealable closure mechanism.

According to another aspect of the present invention, the closure device of the bag resealing system includes a separate guide strip positioned and secured between the resealing mechanism and the support strip that includes one or more guide slits therein. The guide slits, which can be formed as aligned perforations, are used to provide an individual with a guide member for cutting the opening in the bag over which the closure device is located in alignment with the guide opening in the support strip.

According to still another aspect of the present invention, the guide opening formed in the support strip and the guide slits formed in the guide strip are formed to be shorter than the overall length of the closure device. This construction ensures that the attachment of the resealing mechanism to the guide strip and the support strip effectively seals the resealing mechanism to the support strip completely around the guide opening to provide an airtight seal around the guide opening and the opening formed in the bag in alignment with the guide opening.

Numerous other aspects, features, and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is an isometric view of a first embodiment of the bag resealing system constructed according to the present invention;

FIG. 2 is a perspective view of a second embodiment of the bag resealing system of FIG. 1;

FIG. 3 is a side plan view of the slider utilized in the system of FIG. 2;

FIG. 4 is an end plan view of the slider of FIG. 3;

FIG. 5 is an isometric view of a second embodiment of the bag resealing system of FIG. 1; and

FIG. 6 is an exploded isometric view of the resealable closure device of the bag resealing system of FIG. 5.

### DETAILED DESCRIPTION OF THE INVENTION

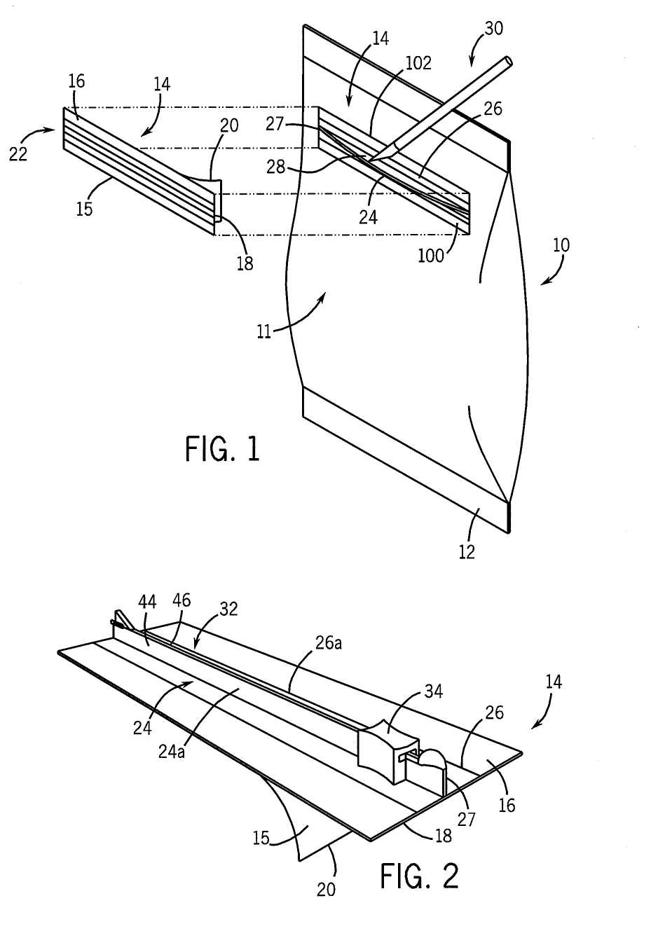

With reference now to the drawing figures in which like reference numerals designate like parts throughout the disclosure, a bag utilized to hold a number of items therein is illustrated generally at 10 in FIG. 1. The bag 10 can be formed of any suitable and easily severable material such as a plastic, paper, or metal foil material, and can have any desired construction that is utilized to hold the item(s) within the bag 10. In one embodiment illustrated in FIG. 1, the bag 10 is sealed at opposed ends 12 to enclose the interior of the bag 10 and hold a number of items therein. Between the sealed ends 12, the structure of the bag 10 has a generally continuous exterior 11 to securely hold the items within the bag 10.

To enable the bag 10 to be selectively opened and closed to gain access to the items held within the bag 10, a bag resealing system 14 constructed according to the present invention can be secured to the bag 10 at any point between the sealed ends 12. The system 14 includes a resealable closure device 15 having a lower support strip 16 that is formed of a suitable material, such as a thermoplastic material, or preferably a paper material, such as those papers utilized in the forming of release liners.

The support strip 16 includes a layer of adhesive 18 positioned along one side thereof. The adhesive 18 can be any suitable type of adhesive, and, preferably, is a pressure sensitive adhesive that permanently affixes the lower support strip 16 to the exterior of the bag 10 when placed into contact with the bag 10. The adhesive 18 is covered by a liner 20 that can be removed from the adhesive 18 in order to expose the adhesive 18 and allow the lower support strip 16 to be adhered to the bag 10 utilizing the adhesive 18.

Opposite the adhesive 18 and the liner 20, the lower support strip 16 is secured to and supports a conventional resealing mechanism 22. As is known in the art, the resealing mechanism 22 includes a pair of appropriately configured opposed portions 24 and 26 that are secured to the support strip 16 at one end and that includes engagement members (not shown) that are releasably engageable with one another at the opposite end. In the embodiments where the support strip 16 is formed of a thermoplastic material, the ends of the support strip 16 can be secured to the portions 24 and 26 in any suitable manner, such as by heat-sealing the support strip 16 to the portions 24 and 26, especially if the materials used to form the respective parts are similar. In addition to heat sealing the support strip 16 to the portions 24 and 26, the support strip 16 can be formed as an integral extension of the material forming the portions 24 and 26, such that the support strip 16 is integrally formed with the portions 24 and 26 at each end. In either embodiment, the amount of each side of the support strip 16 secured to the portions 24 and 26 is preferably made as small as possible in order to enable the distance between the upper ends of the portions 24 and 26 and the support strip 16 to be extended as much as possible, for a purpose to be described.

Opposite the support strip 16, the engagement members on each portion 24 and 26 can be formed with any easily graspable and separable construction as is well known in the art, such that they can be easily disengaged and re-engaged with one another to open and close the mechanism 22. The engagement members are also disposed on generally vertical parts 24a and 26b of each portion 24 and 26, respectively, such that the engagement members are positioned outwardly from and generally perpendicular to the strip 16. (FIGS. 2 and 5-6) In a particularly preferred embodiment, the engagement members on the opposed portions 24 and 26 are positioned apart from the support strip 16 adjacent the upper end of each part 24a and 26a. This enables the length of the vertical parts 24a and 26a, as well as the remainder of the portions 24 and 26 not affixed to the support strip 16, as discussed previously, to provide sufficient clearance within the resealing mechanism 22 to allow the resealing mechanism to be pulled away from the support strip 16 and bag 10, such that the engagement members can be opened after attachment of the device 15 to a bag 10 without pulling on or otherwise damaging the support strip 16 and/or the bag 10. In the disengaged position, the opposed portions 24 and 26 define an opening 27 therebetween that enables access through the mechanism 22.

In a preferred embodiment, the lower support strip 16 is formed of a single piece of material separate from the opposed portions 24 and 26 forming the mechanism 22, and includes an aperture 28 formed therein generally in alignment with the opening 27. In this construction, the pair of opposed portions 24 and 26 of the resealing mechanism 22 can be engaged and disengaged with one another to selectively open and close the resealing mechanism 22, thereby forming the opening 27 and exposing the aperture 28 formed in the support strip 16 immediately adjacent the resealing mechanism 22. Preferably, the aperture 28 extends across the majority of the length of the strip 16. However, the aperture 28 does not extend completely across the strip 16 such that the aperture 28 can be completely enclosed and sealed by the engagement of the opposed portions 24 and 26 of the resealing mechanism 22 with the strip 16, and the engagement of the portions 24 and 26 of the resealing mechanism 22 with one another. This provides the closure device 15 with the capability of forming an airtight seal around the aperture 28 and the associated opening (not shown) formed in the bag 10 to maintain the freshness of the items in the bag 10 for an extended period of time.

To utilize the resealing system 14, a single closure device 15 is obtained, and initially the liner 20 is removed such that the strip 16 is secured to the exterior of the bag 10 utilizing the exposed adhesive 18. The engagement members on the opposed portions 24 and 26 of the resealing mechanism 22 are then disengaged from one another to open the mechanism 22 due to the clearance provided between the bag 10 and the opposed portions 24 and 26 by the support strip 16, thereby defining the opening 27 and exposing the aperture 28 in the strip 16. A suitable cutting device 30 is then inserted through the opening 27 between the opposed portions 24 and 26, and into the aperture 28 to engage the portion of the exterior of the bag 10 disposed in alignment with the aperture 28. The bag 10 is then cut along the aperture 28 using the cutting device 30 to provide the opening in the bag 10 that is disposed in alignment with the aperture 28. Due to the secure attachment of the device 15 to the bag 10 using the unitary support strip 16 with the guide aperture 28 formed therein and the ability to open the mechanism 22 without pulling on and damaging the bag 10, an opening can easily be formed in the bag 10 that is in alignment with the aperture 28 and opening 27 defined by the mechanism 22 supported in the support strip 16. The aperture 28 is formed in the support strip 16 to be preferably at least 0.125 inches wide to assist in cutting the bag 10 with the device 30 through the aperture 28. Access to the items contained within the bag 10 can then be obtained through the opening 27 defined within the mechanism 22, the aperture 28 in the support strip 16 and aligned opening cut into the bag 10. When it is desired to close the bag 10, the opposed portions 24 and 26 of the resealing mechanism 22 are engaged with one another to close the opening 27, simultaneously covering the aperture 28 in the support strip 16 and the opening cut into the bag 10 in an airtight manner.

In a still another embodiment of the system 14′ of the present invention, as best shown in FIGS. 2-4, a sliding closure mechanism 32 is used on the device 15′ in place of the resealing mechanism 22 and is supported and secured on the strip 16′ in alignment with the aperture 28′ in a manner similar to the resealing mechanism 22. The sliding closure mechanism 32 includes a sliding shuttle 34 including a top wall 36, a pair of curved side walls 38, and a central slot 40 defined therebetween. Disposed within the central slot 40 at one end of the shuttle 34 is a separator 42. The shuttle 34 is secured to opposed portions 44 and 46 of the sliding closure mechanism 32 that, in turn, are supported on and secured to the strip 16 in an airtight manner similar to the sections 24 and 26 of the mechanism 22. The separator 42 on the shuttle 34 urges the opposed portions 44 and 46 away from one another to open the sliding closure mechanism 32 and define the opening 27′ therebetween when slid with the shuttle 34 along the closure mechanism 32 in one direction. Additionally, the side walls 38 of the shuttle 34 operate to urge the opposed portions 44 and 46 into engagement with one another and close the opening 27′ when the shuttle 34 is slid along the closure mechanism 32 in the opposite direction.

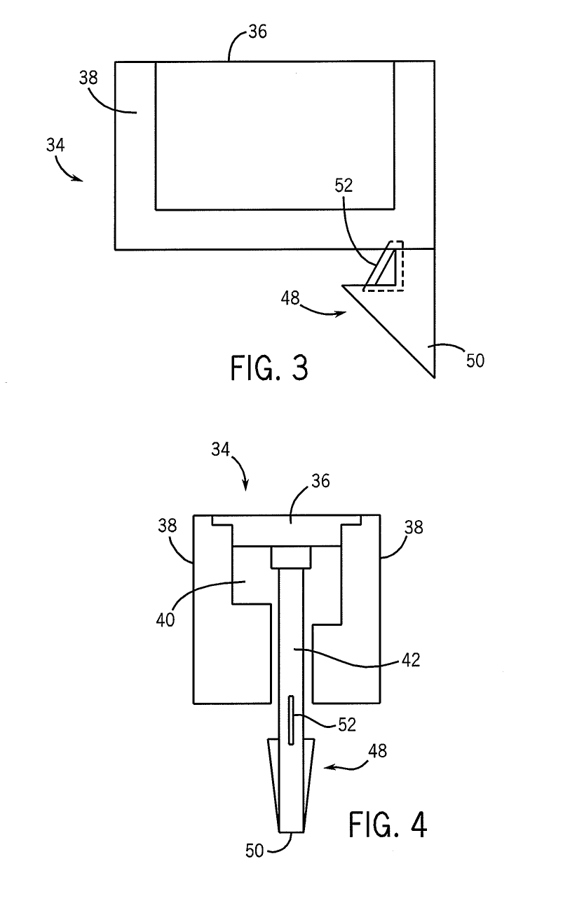

Referring now to FIGS. 3 and 4, the separator 42 optionally, but preferably includes a downwardly extending arm 48 disposed opposite the top wall 36. The arm 48 includes a tapered point 50 spaced from the shuttle 34, and a cutting device or blade 52 disposed on the arm 48 between the shuttle 34 and the point 50. The positioning of the blade 52 on the arm 48 is such that the blade 52 cannot come into contact with an individual either when the device 15′ is being positioned on a bag 10 or when the device 15′ is in use. Further, the arm 48 is formed to have a length slightly longer than the length of the mechanism 32, such that the arm 48 extends through the aperture 28′ in the support strip 16′, with the point 50 and at least part of, and preferably all of, the blade 52 positioned entirely on the opposite side of the support strip 16′ from the mechanism 32.

In operation, when the device 15′ including the slide closure mechanism 32 and the strip 16′ is adhered to a bag 10 utilizing the adhesive 18′ on the strip 16 similarly to the previous embodiments, the point 50 operates to penetrate and form an initial puncture opening (not shown) in the bag 10. When fully attached to the bag 10, the point 50 on the arm 48 is disposed within the bag 10, and the cutting device 52 is positioned in alignment with the exterior surface of the bag 10. In this configuration, when the sliding shuttle 34 is moved along the closure mechanism 32 to separate the opposed portions 44 and 46 utilizing the separator 42 on the shuttle 34, again without tearing the bag 10 due the clearance provided between the mechanism 32 and the bag 10 by the support strip 16′, the cutting device 52 laterally expands the initial puncture opening formed by the point 50 in a direction in alignment with the aperture 28′ in the strip 16′ and the opening 27′ defined by the sliding closure mechanism 32. Thus, when the shuttle 34 is moved completely across the closure mechanism 32, the cutting device 52 subsequently forms an elongate opening (not shown) in the bag 10 in alignment with the aperture 28 in the strip 16′ and the opening 27′ formed between the opposed portions 44 and 46 of the closure mechanism 32. Additionally, when the shuttle 34 is moved back to the original position, the opposed portions 44 and 46 are re-engaged with one another to close the opening 27′ and secure the closure mechanism 32 over the aperture 28 in the strip 16 and the elongate opening in the bag 10. Similarly to the embodiment in FIG. 1, the secure attachment of the device 15′ to the bag 10 using the unitary support strip 16′ with the guide aperture 28′ enables an opening to easily be formed in the bag 10 that is in alignment with the aperture 28′ and opening 27′ defined by the mechanism 32 supported in the support strip 16′.

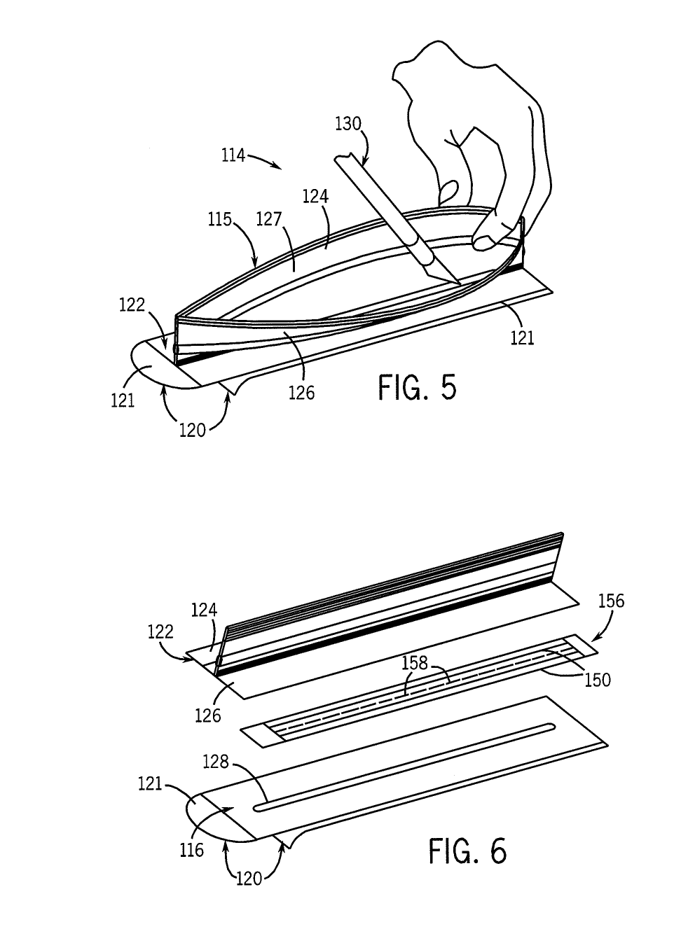

Looking now at FIGS. 5 and 6, still another embodiment of the resealing system 114 is illustrated. In this embodiment, the closure device 115 is formed with a support strip 116 formed of a suitable thermoplastic material, and includes a resealing mechanism 122 positioned thereon that has a pair of opposed, separable portions 124 and 126 secured to the support strip 116 in an airtight manner around the entire periphery of an aperture 128 formed in the support strip 116, as described previously. As a result of the small clearance provided between the bag 10 and the mechanism 122 by the support strip 116, the portions 124 and 126 can be separated to define an opening 127 therebetween and expose the aperture 128 formed in the support strip 116 in alignment with the resealing mechanism 122. The support strip 116 includes a layer of adhesive 118 applied thereto opposite the resealing mechanism 122, and is preferably formed of a pressure sensitive adhesive, but other suitable adhesives can also be utilized. A backing or liner 120 is positioned over the adhesive layer 118 to prevent the layer 118 from prematurely adhering to a surface other than the exterior of the bag 10. The liner 120 is formed of any suitable material, such as a suitable coated paper, and may include a tab 121 disposed on one side of the liner 120 that extends outwardly past the support strip 116 to assist in grasping and removing the liner 120 from the adhesive layer 118.

Additionally, the device 115 includes a separate guide strip 156 disposed between the strip 116 and the resealing mechanism 122. The guide strip 156 is formed from a suitable material, such as a material similar to that forming the strip 116, but is preferably formed from a paper material. The guide strip 156 is dimensioned to have a length and width sufficient to completely cover the aperture 128 in the strip 116 when positioned on the strip 116. However, the length and width of the guide strip 156 are also preferably sufficiently short so as not to interfere with the airtight seal formed between the strip 116 and the portions 124 and 126 of the resealing mechanism 122. However, the guide strip 156 can also be formed to be coextensive with the mechanism 122, such that the guide strip 156 forms an integral part of the sealing engagement between the mechanism 122 and the support strip 116.

The guide strip 156 includes at least one guide slit 158, and preferably a line of slits or perforations, extending along the length of the perforated strip 156 in alignment with the aperture 128 formed in the strip 116. The function of the guide strip 156 and guide slits 158 is to provide a guide for a cutting device 130 inserted through the opening 127 formed in the resealing device 122 and used to form the opening in the bag 10. The guide slits 158 assist in maintaining the cutting device 130 in alignment with the aperture 128 such that the opening in the bag 10 is properly aligned with the aperture 128. The guide slits 158 do not extend completely across the guide strip 156, such that the ends of the guide strip 156 operate to prevent the individual from cutting too far along the guide strip 156. This in turn prevents the individual from damaging the airtight seal formed between the strip 116 and the resealing mechanism 122 around the guide strip 156 and aperture 128. Alternatively, the endmost guide slit 158 can be formed with circular outer ends (not shown) to assist in preventing any further cutting along the guide strip 156.

The guide strip 156 may also include one or more guide lines 160 disposed on the guide strip 156 adjacent and in alignment with the guide slits 158. The guide line(s) 160 function to further assist an individual in cutting the exterior of the bag 10 in alignment with the aperture 128. These guide lines 160 can be printed on the guide strip 156 and colored as necessary depending upon the color of the guide strip 156 and/or the color of the bag 10 to which the device 115 is secured. Also, there may be multiple guide lines 160 on the guide strip 156 in multiple colors positioned on opposed sides of the guide slits 158. In certain alternative embodiments, the lower strip 116 and the perforated strip 156 can be combined into a single structure where the guide slits 158 take the place of the aperture 128 in the support strip 116.

Various alternatives are contemplated as being within the scope of the following claims particularly pointing out and distinctly claiming the subject matter regarded as the invention.

What is claimed is:

1. A bag resealing system adapted to be secured to the exterior of a bag containing a number of items therein, the bag resealing system comprising:
a) a support strip adapted to be positioned against the exterior of a bag and including an adhesive disposed along one side of the support strip and defining at least one aperture therein; and
b) a closure mechanism disposed on the support strip opposite the adhesive, the closure mechanism including a pair of opposed sections releasably engageable with one another to selectively open and close the closure mechanism, wherein the placement of the closure mechanism on the support strip provides clearance between the closure mechanism and the support strip to enable the mechanism to open and define an opening therein in alignment with the at least one aperture.

2. The system of claim 1 wherein the closure mechanism includes a sliding shuttle thereon.

3. The system of claim 2 wherein the sliding shuttle includes a cutting blade disposed on the shuttle and adapted to form an elongate opening in the bag to which the system is attached.

4. The system of claim 3 wherein the sliding shuttle includes a puncture mechanism disposed on the shuttle and adapted to form an initial opening in the bag to which the system is attached.

5. The system of claim 1 wherein the closure mechanism is secured in an airtight manner around the entire periphery of the at least one aperture in the support strip.

6. The system of claim 5 wherein the opposed sections are each fixedly attached to the support strip.

7. The system of claim 6 wherein the opposed sections are fixedly secured to the support strip on opposite sides of the at least one aperture.

8. The system of claim 7 wherein the at least one aperture has a width of approximately 0.125 inches.

9. The system of claim 1 further comprising a guide strip disposed between the support strip and the closure mechanism, the guide strip including a number of aligned perforations therein.

10. The system of claim 9 wherein the closure mechanism is attached in an airtight manner to the support strip around the entire periphery of the at least one aperture in the support strip and the guide strip.

11. The system of claim 10 wherein the guide strip is thermally bonded between the closure mechanism and the support strip.

12. The system of claim 9 wherein the guide strip includes a number of guide lines printed thereon in alignment with the perforations.

13. The system of claim 1 further comprising a cutting device adapted to cut the bag along the aperture formed in the support strip.

14. A kit for a bag resealing system for use with flexible bags, the kit comprising:
a) a number of resealable closure devices formed with a support strip defining at least one aperture therein and a closure mechanism secured to the support strip in an airtight manner around the entire periphery of the at least one aperture, wherein the placement of the closure mechanism on the support strip provides clearance between the closure mechanism and the support strip to enable the mechanism to open and define an opening therein in alignment with the at least one aperture; and
b) at least one cutting device adapted to cut the bag through the at least one aperture in the support strip.

15. A method for forming an access opening in an exterior of a flexible container, the method comprising the steps of:
a) providing a bag resealing system comprising a support strip including an adhesive disposed along one side of the support strip and defining at least one aperture therein, and a closure mechanism disposed on the support strip opposite the adhesive in an airtight manner around the entire periphery of the at least one aperture and including a pair of opposed sections releasably engageable with one another, wherein the placement of the closure mechanism on the support strip provides clearance between the closure mechanism and the support strip to enable the opposed sections to selectively open and close to define an opening therebetween in alignment with the at least one aperture;
b) securing the support strip to the exterior of the container;
c) opening the closure mechanism to expose the exterior of the container covered by the system; and
d) forming the access opening in the exterior of the container within the system.

16. The method of claim 15 wherein the step of forming the access opening comprises the steps of:
a) placing a cutting device within the closure mechanism;
b) engaging the cutting device with the exterior of the container; and
c) moving the cutting device along the exterior of the container.

17. The method of claim 16 wherein the method further comprises the step of moving the cutting device along the at least one aperture simultaneously with moving the cutting device along the exterior of the container.

18. The method of claim 16 wherein the system further comprises a guide strip positioned between the support strip and the closure mechanism, the guide strip having a line of perforations therein aligned with the at least one aperture in the support strip, and wherein the method further comprises the step of pressing the cutting device through the line of perforations prior to inserting the cutting device into the at least one aperture.

19. The method of claim 18 wherein the method further comprises the step of moving the cutting device along the line of perforations simultaneously with moving the cutting device along the exterior of the container.

20. The method of claim 16 wherein the closure mechanism includes a cutting device therein, and wherein the step of opening the closure mechanism occurs simultaneously with the step of forming the access opening.

21. The method of claim 16 further comprising the step of closing the closure mechanism after forming the access opening.

22. A bag resealing system adapted to be secured to the exterior of a bag containing a number of items therein, the bag resealing system comprising:
a) a support strip adapted to be positioned against the exterior of a bag and including an adhesive disposed along one side of the support strip and defining at least one cutting zone therein; and
b) a closure mechanism disposed on the support strip opposite the adhesive, the closure mechanism to selectively open and close the closure mechanism, wherein the placement of the closure mechanism on the support strip provides clearance between the closure mechanism and the support strip to enable the mechanism to open and define an opening therein in alignment with the at least one cutting zone.

23. The system of claim 22 wherein the at least one cutting zone includes at least one aperture.

24. The system of claim 22 wherein the at least one cutting zone includes at least one guide line.

25. The system of claim 22 wherein the closure mechanism is secured in an airtight manner around the entire periphery of the at least one cutting zone.

26. The system of claim 22 wherein the closure mechanism includes a pair of opposed sections releasably engageable with one another to selectively open and close the closure mechanism.

27. A bag resealing system adapted to be secured to the exterior of a bag containing a number of items therein, the bag resealing system comprising:
a) a support strip adapted to be positioned against the exterior of a bag and including an adhesive disposed along one side of the support strip and defining at least one cutting zone therein; and
b) a closure mechanism disposed on the support strip opposite the adhesive, the closure mechanism including a pair of opposed sections releasably engageable with one another to selectively open and close the closure mechanism, wherein the placement of the closure mechanism on the support strip provides clearance between the closure mechanism and the support strip to enable the mechanism to open and define an opening therein in alignment with the at least one cutting zone.

28. A method for forming an access opening in an exterior of a flexible container, the method comprising the acts of:
a) providing a bag resealing system comprising a support strip including an adhesive disposed along one side of the support strip and defining at least one cutting zone therein, and a closure mechanism disposed on the support strip opposite the adhesive in an airtight manner around the entire periphery of the at least one cutting zone, wherein the placement of the closure mechanism on the support strip provides clearance between the closure mechanism and the support strip to enable the closure mechanism to selectively open and close to define an opening therebetween in alignment with the at least one cutting zone;
b) securing the support strip to the exterior of the container;
c) opening the closure mechanism to expose the exterior of the container covered by the system; and
d) forming an access opening in the exterior of the container within the system.

29. The method of claim 28 wherein the act of forming the access opening comprises the acts of:
a) placing a cutting device within the closure mechanism; and
b) engaging the cutting device with the exterior of the container through the at least one cutting zone.
